(19) United States
(12) Patent Application Publication
(10) Pub. No.: US 2010/0216037 A1
(43) Pub. Date: Aug. 26, 2010

(54) CARBON-FILLED POLYMER COMPOSITE BIPOLAR PLATES FOR PROTON EXCHANGE MEMBRANE FUEL CELLS

(75) Inventors: Sadhan C. Jana, Fairlawn, OH (US); Ling Du, Akron, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/521,368

(22) PCT Filed: Dec. 14, 2007
(86) PCT No.: PCT/US07/25705

§ 371 Date: Apr. 20, 2010

Related U.S. Application Data
(60) Provisional application No. 60/877,207, filed on Dec. 26, 2006.

(51) Int. Cl. H01M 8/00; C08K 3/04

(52) U.S. Cl. 429/400; 264/331.12; 521/28

(57) ABSTRACT

Proton exchange membrane (PEM) fuel cells, also known as polymer electrolyte membrane fuel cells, consist of a proton conducting membrane or a proton exchange membrane possessing adequate proton conducting properties typically contained between two platinum impregnated porous electrodes. PEM fuel cells are used in the transportation, stationary and portable applications and are currently used in the automobile industry as the fuel cell favored for replacement of the internal combustion engine. An opportunity exists for the development of lightweight and highly conductive polymer-based bipolar plates produced by standard mass production techniques, such as extrusion or compression and injection molding. The present invention capitalizes this opportunity and discloses method and compositions of matter for manufacturing of lightweight, low cost carbon-filled polymer composite bipolar plates.

### RELATED APPLICATION DATA

This application is related to currently pending U.S. Provisional Application No. 60/877,207, entitled “Carbon-Filled Polymer Composite Bipolar Plates for Proton Exchange Membrane Fuel Cells” filed on Dec. 26, 2006, which is incorporated herein by reference in its entirety.

### FIELD OF THE INVENTION

Proton exchange membrane (PEM) fuel cells, also known as polymer electrolyte membrane fuel cells, consist of a proton conducting membrane or a proton exchange membrane possessing adequate proton conducting properties typically contained between two platinum impregnated porous electrodes. PEM fuel cells are used in the transportation, stationary and portable applications and are currently used in the automobile industry as the fuel cell favored for replacement of the internal combustion engine.

### BACKGROUND OF THE INVENTION

A proton exchange membrane fuel cell transforms the chemical energy liberated during the electrochemical reaction of hydrogen and oxygen to electrical energy, as opposed to the direct combustion of hydrogen and oxygen gases to produce thermal energy. A stream of hydrogen is delivered to the anode side of a membrane-electrode assembly. At the anode side, the stream is typically split into protons and electrons. The newly formed protons created permeate through the polymer electrolyte membrane to the cathode side. The electrons travel along an external load circuit to the cathode side of the membrane-electrode assembly, creating the current output of the fuel cell. Meanwhile, a stream of oxygen is delivered to the cathode side of the membrane-electrode assembly. At the cathode side, oxygen molecules react with the protons permeating through the polymer electrolyte membrane and the electrons arriving through the external circuit to form water molecules. In a typical PEM fuel cell, the electrolyte is a thin polymer membrane permeable to protons, but the membrane does not conduct electrons. The electrodes used are typically made from carbon. PEM cells typically operate at a temperature of around 80° C. With the electrochemical reaction at this temperature being slow, a thin layer of platinum is typically added as a catalyst.

The electrode/electrolyte unit described above is called a membrane electrode assembly (MEA) and it is sandwiched between two field fuel plates to create the fuel cell. These plates typically contain grooves to channel the fuel to the electrodes and conduct electrons out of the assembly. Typically these cells produce a small voltage output, thereby necessitating several individual cells combined in series to form a structure referred to as a fuel cell stack.

Conventional graphite and metallic bipolar plates for PEM fuel cells are costly and heavy. These weight issues present specific problems in transportation and portability applications. An opportunity exists for the development of lightweight and highly conductive polymer-based bipolar plates produced by standard mass production techniques, such as extrusion or compression and injection molding. The present invention capitalizes this opportunity and discloses method and compositions of matter for manufacturing of lightweight, low cost carbon-filled polymer composite bipolar plates.

### SUMMARY OF INVENTION

The present invention offers a low cost and lower density alternative in the form of polymer composites bipolar plates. As polymers are poor electrical and thermal conductors, a synergistic combination of expanded graphite and conductive carbon black is used in the present invention to obtain high values of through-plane and in-plane electrical conductivity in polymeric composite bipolar plates. The resultant polymeric composites also offer strong mechanical properties and high thermal conductivity. The bipolar plates produced in the present invention have similar mechanical properties and desired thermal conductivity, but offer higher in-plane and through-plane electrical conductivity than commercial polymer composite bipolar plates.

The present invention discloses polymer composite bipolar plates of carbon-filled thermosetting epoxy produced by compression molding. The polymer composites are made by compression molding mixtures of epoxy, epoxy curing agent, expanded graphite, and conductive carbon black. The curing reaction between epoxy and epoxy curing agent is triggered at the time of compression molding to obtain composite materials with strong mechanical properties and high electrical conductivity. The cured composite withstands continuous operating temperatures in the range 30-200° C. without a deterioration of mechanical integrity. A synergistic combination of expanded graphite and particulate conductive carbon black enables the composite to be electrically conductive for both in-plane and through-plane directions. Polymer composites produced with synergistic combinations of conductive fillers provide higher in-plane and through-plane electrical conductivity compared to composites prepared separately with expanded graphite or conductive carbon black at or near the same carbon loading. Also, composites of expanded graphite and epoxy lacking conductive carbon black provide very low through-plane conductivity, while those containing conductive carbon black and epoxy without expanded graphite provide low values of through-plane and in-plane electrical conductivity. The epoxy composites produced in the present invention provide high in-plane electrical conductivity in the range of 200-500 S/cm, a range much higher than the Department of Energy (DoE) target of 100 S/cm, and higher than most commercial polymer composite bipolar plates offering electrical conductivities in the range of 200-300 S/cm. Furthermore, epoxy composites of the present invention offer higher glass transition temperatures (150-200° C.) and thermal degradation temperatures (350-400° C.). In addition, adequate chemical stability has been established under acidic, humid, and high temperature environments making the invention suitable for PEM fuel cell applications.

In one embodiment the present invention discloses a method of manufacturing a polymer composite bipolar plate for use in a proton exchange membrane fuel cell comprising: providing at least one epoxy, at least one curing agent, at least one graphite and at least one carbon black to a mixture, and compression molding the mixture to initiate the curing reaction between the epoxy and curing agent.

In another embodiment the present invention discloses a polymer composite for use as a bipolar plate in a proton exchange membrane fuel cell comprising: at least one epoxy present from about 40 to about 60 weight percent, at least one curing agent, at least one graphite present from about 35 to about 60 weight percent, and at least one carbon black present at less than about 5 weight percent.

### BRIEF DESCRIPTION OF THE DRAWINGS

FIG. 1 is a schematic diagram of the preparation procedure of epoxy composites;

FIG. 2 is a diagram detailing the experimental setup for measuring in-plane conductivity with four-point probe method;

FIG. 3 is a graph detailing the in-plane conductivity of EP100 composites with 5 wt % carbon black;

FIG. 4a is a graph detailing the in-plane conductivity of EP90 composites with 5 wt % carbon black or without carbon black filler;

FIG. 4b is a graph detailing the in-plane conductivity of epoxy composites as functions of EG content at 5 wt % CB;

FIG. 5a is a graph detailing the in-plane conductivity of EP100 composites with 5 wt % carbon black or without carbon black filler;

FIG. 5b is a graph detailing the in-plane conductivity of Epoxy 90 composites as function of total filler content with or without CB;

FIG. 6 is a schematic diagram of the fixture used to measure through-plane conductivity;

FIG. 7 is a schematic showing the structure of epoxy/expanded graphite/carbon black;

FIG. 8 is a schematic illustration of the position of (a) CB particles in space between two EG platelets, and (b) corresponding resistances in series in composites;

FIG. 9 are SEM images of EP90/expanded graphite/carbon black (50/50/0) (a and b) and EP90/expanded graphite/carbon black (50/45/5) (c and d);

FIG. 10 is a chart showing the water absorption profile of epoxy resin and composites during water and acid reflux;

FIG. 11 is a chart showing the electrical conductivity of composites as a function of time after reflux with acid and water;

FIG. 12 details SEM micro-structures images of expanded graphite (a), (b) and (c), and synthetic graphite (d); and

FIG. 13 is a graph detailing oxygen transmission rates of epoxy composites as functions of EG content.

### DETAILED DESCRIPTION OF THE INVENTION

The present invention discloses polymer composite bipolar plates of carbon-filled thermosetting epoxy produced by compression molding. The polymer composites are made by compression molding mixtures of epoxy, epoxy curing agent, expanded graphite, and conductive carbon black. The curing reaction between epoxy and epoxy curing agent is triggered at the time of compression molding to obtain composite materials with strong mechanical properties and high electrical conductivity. The cured composite withstands continuous operating temperatures from about 30° C. to about 200° C. without a deterioration of mechanical integrity. A synergistic combination of expanded graphite and particulate conductive carbon black enables the composite to be electrically conductive for both in-plane and through-plane directions. Polymer composites produced with synergistic combinations of conductive fillers provide higher in-plane and through-plane electrical conductivity compared to composites prepared separately with expanded graphite or conductive carbon black at or near the same carbon loading. Also, composites of expanded graphite and epoxy lacking conductive carbon black provide very low through-plane conductivity, while those containing conductive carbon black and epoxy without expanded graphite provide low values of through-plane and in-plane electrical conductivity. The epoxy composites produced in the present invention provide high in-plane electrical conductivity in the range of about 200 to about 500 S/cm, such a range is higher than the Department of Energy (DoE) target of 100 S/cm, and higher than most commercial polymer composite bipolar plates offering electrical conductivities in the range of 200 to 300 S/cm. Furthermore, the epoxy composites of the present invention offer higher glass transition temperatures in the range of about 150° C. to about 200° C. and thermal degradation temperatures in the range of about 350° C. to about 400° C. In addition, adequate chemical stability has been established under the acidic, high humidity, and high temperature environments of PEM fuel cell applications.

### Conductive Carbon Black and Expanded Graphite

Conductive carbon blacks is known the art and are carbon blacks with high to very high void volume allowing the retention of a carbon network at low to very low filer content. The void volume can originate from the interstices between the carbon black particles, due to their complex arrangement, and from the porosity.

Expanded graphite is known in the art and is manufactured from natural graphite flakes with well-ordered crystalline structures. Graphite's carbon atoms being arranged in a hexagonal lattice of superimposed parallel planar structures. During the production process in one embodiment, the graphite flakes increase in volume by a factor of 200 to 400; the natural graphite expanding to form a loose-textured vermicular structure of pure graphite, which can be further processed as required. Advantages to expanded graphite include low weight combined with high thermal and electrical conductivity.

### Method of Preparation of Composites

in one embodiment the polymeric portion of the composites are constituted from an aromatic epoxy, diglycidyl ether of bisphenol A (DGEBPA) in the form of Epon® 826 from Resolution Performance Products (Houston, Tex.) with epoxide equivalent weight of 178-186, viscosity of 65-95 Pas, and specific gravity of 1.15 at 25° C. or its mixtures with an aliphatic epoxy, polypropyleneglycol glycidyl ether, in the form of Araldite® DY3601 of Vantico (Brewster, N.Y.) with epoxide equivalent weight of 385-405, viscosity of 0.42-0.52 Pa·s, and specific gravity of 1.03 at 25° C. The aromatic to aliphatic epoxy are mixed in proportions of 100:0, 90:10, 80:20, and 70:30, all by weight.

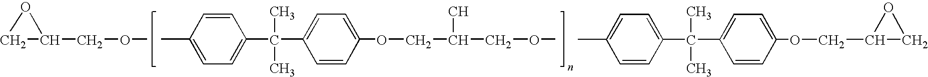

Epon® 826: Diglycidyl ether of bisphenol A (DGEBA); n=0.085, EEQ=178-186

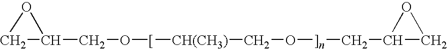

Araldite® DY3601: Polypropylene glycol diglycidyl ether; n=11.4, EEQ=385-405
Epoxy molecules are crosslinked or cured using an aromatic diamine, diaminodiphenylsulphone (DDS) from Ciba (Tarrytown, N.Y.) with trade name HT976, with melting temperature 180° C.

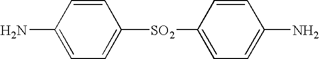

DDS: Diaminodiphenylsulphone, MW=248 g/mol
   Two types of high electrically conductive carbon blacks, KETJENBLACK® EC-300J and EC-600JD from Akzo Nobel Chemicals Inc. (Chicago, Ill.) are used. Four types of expandable graphite, GRAFGUARD® Expanding Flake 160-50N, 160-80N, 220-50N and 220-80N (GrafTech) are used.

Epoxy resins are prepared by mixing Epon® 826 and Araldite® Dy3601 in a beaker at room temperature in a desired weight ratio, followed by addition of curing agent DDS (with 5 wt % excess over stoichiometric). The mixture is heated to 135° C. and stirred until the mixture turns transparent. In another embodiment, epoxy resins and DDS are added to acetone in a beaker and stirred until the solution becomes clear.

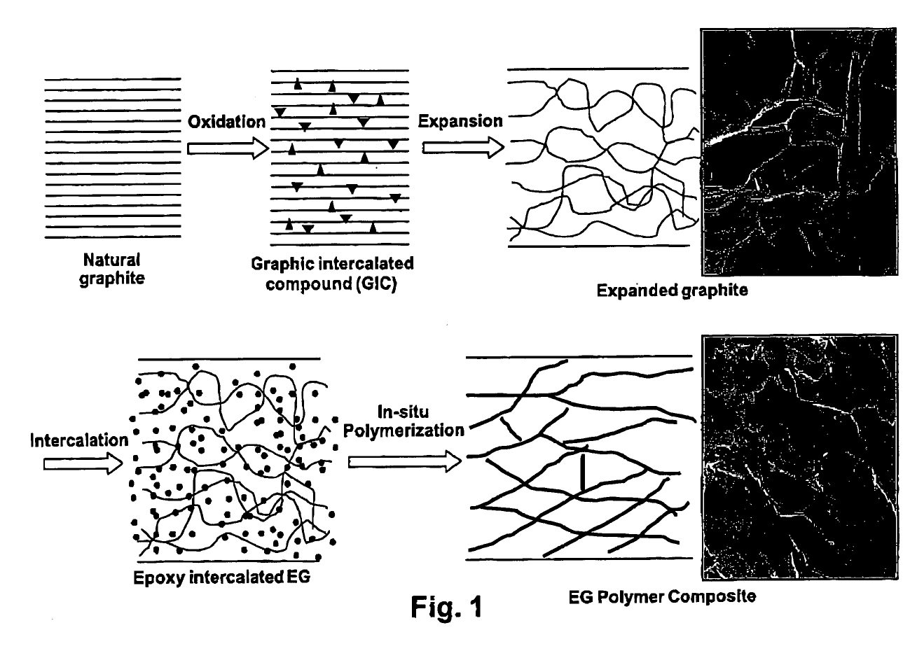

Carbon-filled epoxy composites are prepared by solution intercalation method shown in FIG. 1. Conductive fillers, i.e. expanded graphite (EG) and carbon black (CB), are added into the mixture of epoxy resins, curing agent, and acetone. The mixture is stirred for 6 hours to promote intercalation of expanded graphite layers by molecules of epoxy resin and curing agent at the end of which acetone is evaporated and the materials dried for 24 hours at 60° C. under vacuum. The dried materials are compression molded at 180° C. with application of a pressure of 4000 psi for 4-6 hours. The total filler content in the composite varies from about 40 wt % to about 70 wt % of which a maximum of about 5 wt % is CB.

Measurement of in-Plane and Through-Plane Electrical Conductivity

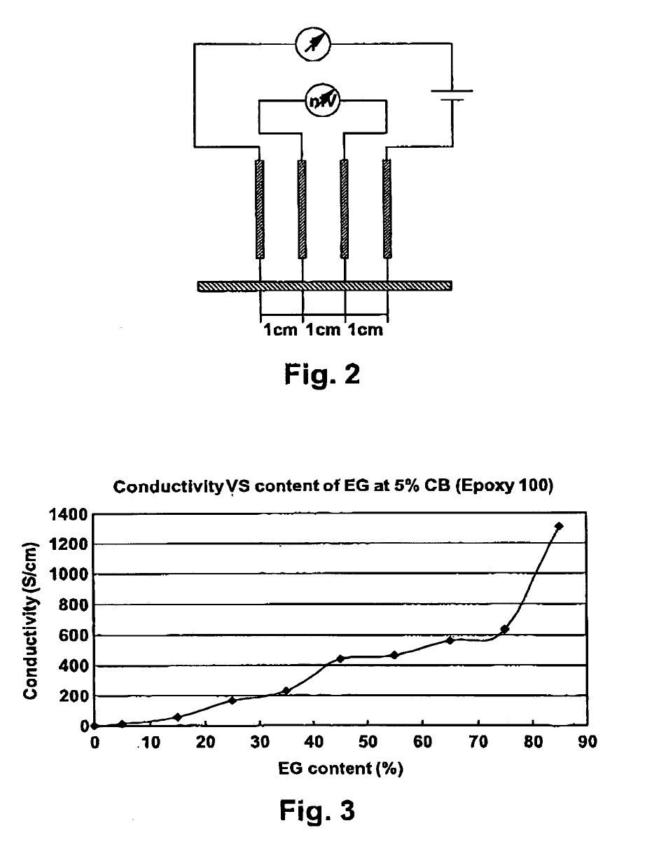

A four probe conductivity measurement device detailed in FIG. 2 is used for measurement of in-plane electrical conductivities. The specific resistance (ρ) and specific conductivity (σ) are computed as follows:

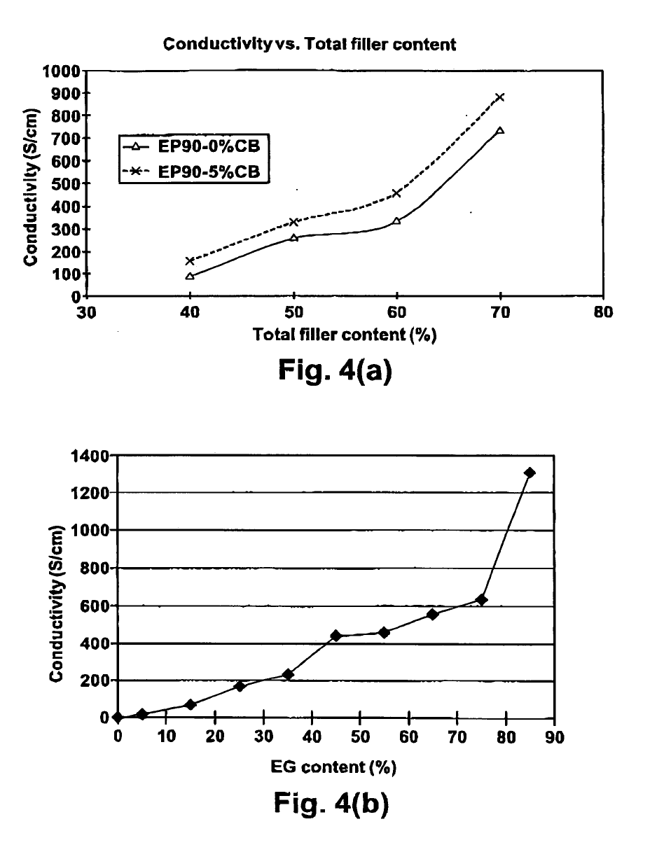

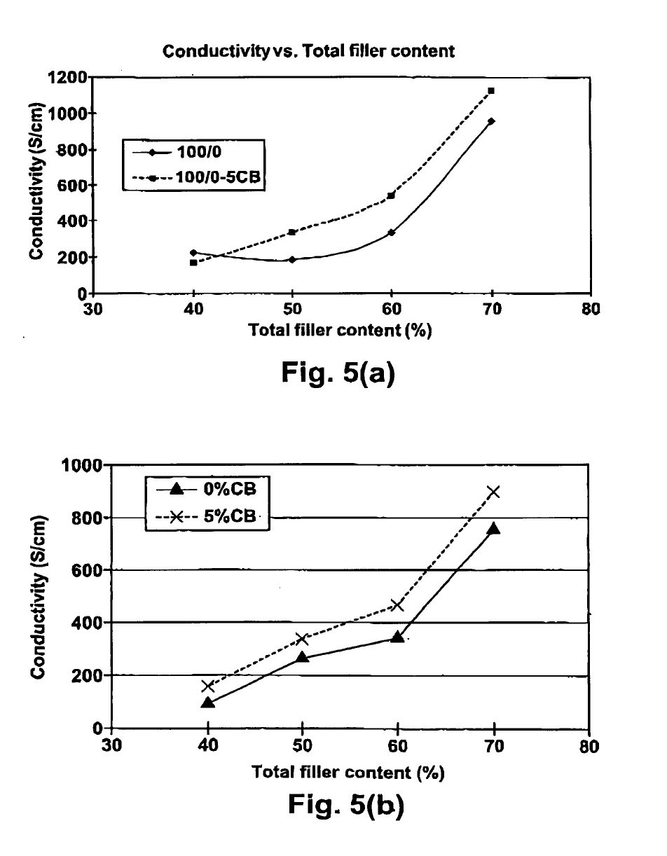

ρ=RA/L; σ=1/ρ

where R is the resistance of the sample measured by the four probe device and L is the thickness of the sample. A set of representative in-plane electrical conductivity data is shown in FIGS. 3 through 5.

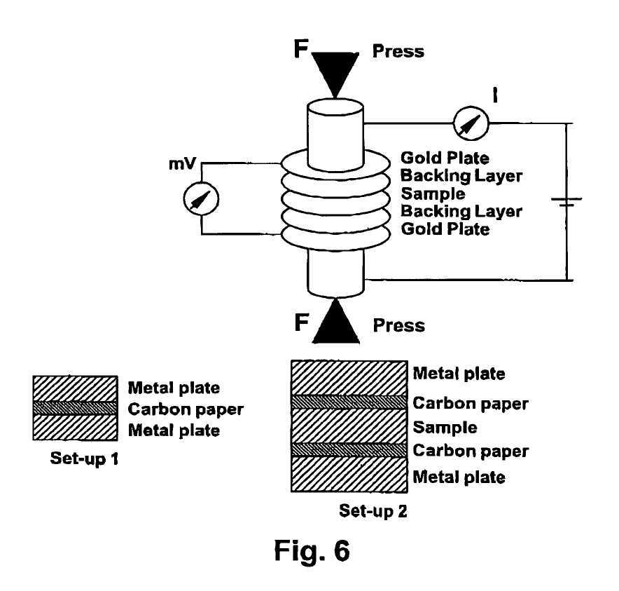

The through-plane electrical conductivity is more important for the application of these materials as bipolar plates. The through-plane conductivities are measured using a fixture specifically designed, whereby a desired pressure is applied during measurement as shown in FIG. 6.

The through-plane conductivity is calculated using the following equations:

$${R}_{Material} = {R}_{Set \text{-} up 2} - 2 {R}_{Set \text{-} up 1}$$

$$Resistivity = Resistance \times \frac{contact area}{sample thickness}$$

which leads to conductivity values of 77 S/cm for EP90/EG/CB(50/50/0) and 76 S/cm for EP90/EG/CB(50/45/5) with EPON 826:DY3601 ratio maintained at 90:10 by weight.

### Synergistic Effect of Combination of Fillers

The synergistic effect of the conductive fillers apparent in FIG. 3 though 5 can be explained as follows. The macroscopic resistance between conductive particles in the polymer composite depends on two contributions: (1) resistance of aggregate, Ra=ρᵢ/d, where ρᵢ is the resistivity of the filler, and d is the diameter of the contact area and (2) resistance of the inter-aggregate space Re, resulting from the tunneling resistance. An expression of Re can be written as Re=ρ_{c}/A, where ρₜ is the tunneling resistivity, and A is the contact surface area of the particles. The total resistance of a composite, R, is the sum of all aggregate resistances Rₐ, and interaggregate space resistances R_{e, i}, with R=ΣR_{a, i}+ΣR_{e, i}.

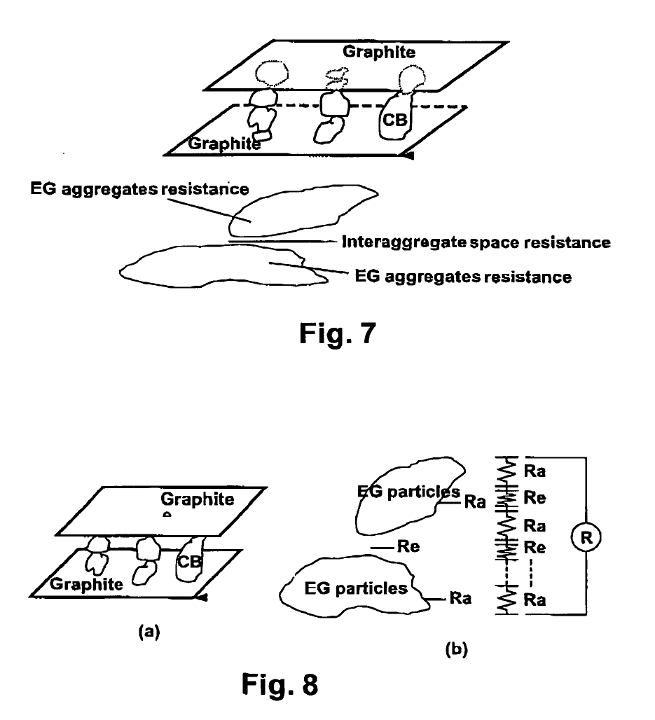

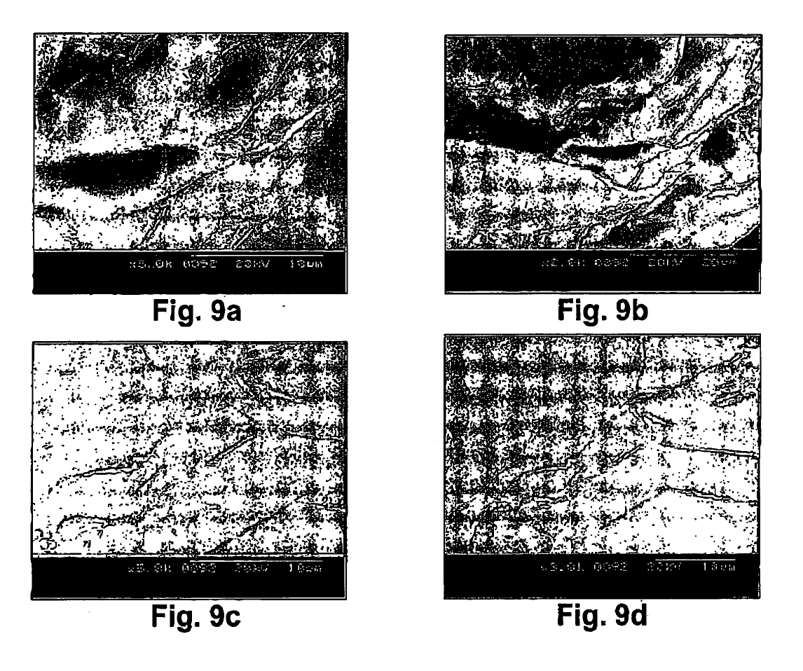

FIG. 7 schematically details the structure and resistance contributions of the composites. FIG. 8 details the position of CB particles in space between two EG platelets and corresponding resistances in series, in composites. The resistance of EG particles is very small, owing to high value of intrinsic conductivity. Therefore, in this case, the total resistance derives primarily from the resistance of the inter-aggregate space, Re. Accordingly, CB particles added to epoxy/EG composites generate connection between EG layers thus reducing the value of Re, and therefore the total resistance. Carbon black (CB) efficiently imparts electrical conductivity with minimal loading due to highly branched structures, high surface areas, and small aggregates sizes. The morphology differences between epoxy/EG and epoxy/EG/CB composites are compared in FIG. 9. These SEM (scanning electron microscope) images clearly show CB particles uniformly distributed in the composites, and the many CB aggregates between graphite layers imparting both in-plane and through-plane conductivity between adjacent graphite layers. In this manner, Re was largely reduced, resulting in a lower value of total resistance or higher total conductivity of the epoxy/EG/CB composites.

### Thermal Properties

The epoxy composites of the present invention offer high glass transition and thermal degradation temperatures as shown in Tables 1 and 2. The data in Tables 1 and 2 establishing that the composites as thermally stable under the fuel cell operating temperature of 80° C.

TABLE 1
Glass transition and thermal degradation
temperatures of epoxy resins.

| Epoxy | | | |
|---|---|---|---|
| resins | T_{g} (° C.) | T₁(° C.) | T₂(° C.) |
| EP100 | 201 | 400 | 425 |
| EP90 | 182 | 390 | 424 |
| EP80 | 111 | 395 | 430 |
| EP70 | 99 | 381 | 410 |

TABLE 2
Glass transition and thermal degradation temperatures
of epoxy resins and composites.

| EP90/EG/CB | T_{g} (° C.) | T₁ (° C.) | T₂ (° C.) |
|---|---|---|---|
| 100/0/0 | 182 | 390 | 424 |
| 50-50-0 | 177 | 389 | 414 |
| 50-45-5 | 174 | 370 | 403 |
| 40-60-0 | 179 | 385 | 415 |
| 40-55-5 | 179 | 368 | 402 |

### Chemical Resistance Against Acid and Water Refluxes

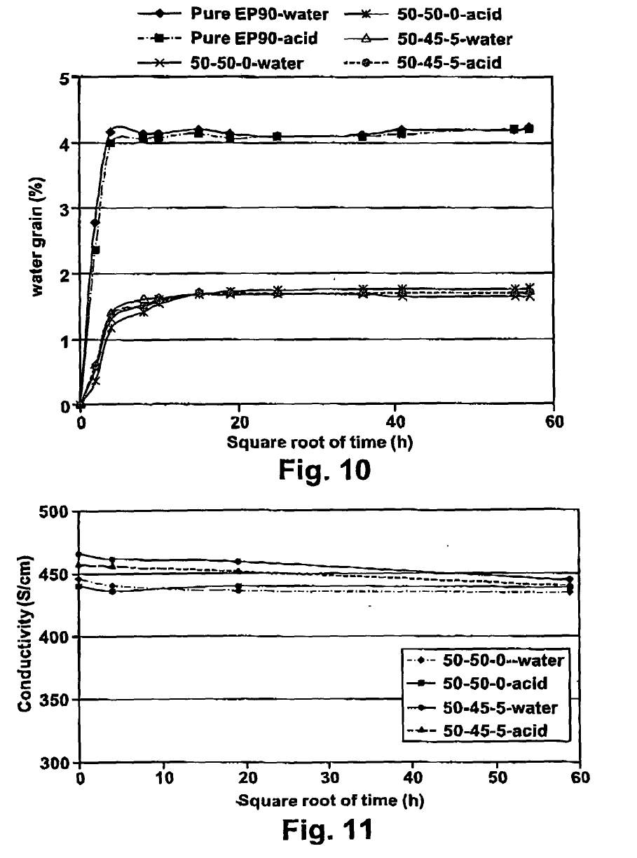

Good chemical stability of the composites is established under the acidic, humid and high temperature environment present in the PEM fuel cell operating conditions. Acid reflux and water reflux experiments are used to evaluate the chemical stability of the resin and its composites. The water absorption profile is detailed in FIG. 10. The maximum water gain and the diffusivity of water into epoxy resin and composites are calculated by the following equations. The resulting data is shown in Table 3.

TABLE 3
$M \% = \frac{( W - {W}_{d} )}{{W}_{d}} \times 100 \%$ $D = \frac{π}{16} {( \frac{h}{{M}_{m}} )}^{2} {( \frac{{M}_{t 2} - {M}_{t 1}}{\sqrt{{t}_{2}} - \sqrt{{t}_{1}}} )}^{2}$
Maximum water gain (M) and Diffusivity (D) of epoxy resin and
composites during water and acid reflux

| EP90/EG/CB | M (%) (6 months) | D (×10⁻⁶) (mm²/s) |
|---|---|---|
| 100/0/0-water | 4.22 | 8.4 |
| 100/0/0-acid | 4.20 | 10.2 |
| 50/50/0-water | 2.00 | 1.0 |
| 50/50/0-acid | 1.70 | 0.90 |
| 50-49-1-water | 1.62 | 0.46 |
| 50-49-1-acid | 1.59 | 0.34 |
| 50-48-2-water | 1.61 | 0.43 |
| 50-48-2-acid | 1.80 | 0.41 |
| 50/47/3-water | 1.77 | 0.53 |
| 50/47/3-acid | 1.72 | 0.52 |
| 50-46-4-water | 1.96 | 0.39 |
| 50-46-4-acid | 1.91 | 0.36 |
| 50/45/5-water | 1.46 | 0.69 |
| 50/45/5-acid | 1.52 | 0.66 |
| 50-44-6-water | 1.76 | 0.69 |
| 50-44-6-acid | 1.81 | 0.54 |

It is observed that the dimensions and appearance of the samples do not change upon acid reflux, proving the materials are chemically stable under highly acidic and high temperature conditions.

FIG. 11 indicates that hygrothermal effects on electrical conductivity of the EP composites are very small as very little change in conductivity is observed in materials after water and acid reflux.

In addition to electrical conductivity, the bipolar plates also possess good mechanical properties to support thin membrane and electrodes, and decent clamping forces for the stack assembly. The DOE target values for flexural, tensile and impact strengths are 59 MPa, 41 MPa and 40.5 J/m respectively. However for composites to be used as bipolar plates, they must also possess high electrical conductivity such as a DOE target value of 100 S/cm. High filler loading causes voids and defects in the composites, especially if the filler loading is higher than the critical pigment volume concentration (CPVC). As a result, it is difficult to attain the high electrical conductivity and the desired mechanical properties simultaneously. The materials described in this invention however possess desired mechanical strength as shown in Table 4. The flexural and impact strengths are much higher than the DOE target values. The flexural properties for various embodiments were measured by using ASTM D790-03 method, while ASTM D 4812-99 and ASTM D 638-84 methods were used for impact and tensile properties. The bipolar plates also possess good thermal conductivity to diffuse the reaction heat away from the membrane surface as shown in Table 4.

TABLE 4
Mechanical properties of epoxy composites
compared with DOE target values

| | Flexural | Flexural | Flexural | Tensile | Impact | Thermal |
|---|---|---|---|---|---|---|
| EP90/ | Modulus | Strength | Strain | Strength | Strength | conductivity |
| EG/CB | (MPa) | (MPa) | (%) | (MPa) | (J/m) | (W/m · K) |
| 60-40-0 | 1.77 × 10⁴ | 61 | 0.37 | 40 | | 13.5 |
| 60-35-5 | 0.75 × 10⁴ | 40 | 0.56 | 29 | | |
| 50-50-0 | 2.08 × 10⁴ | 72 | 0.50 | 37 | 173 | 56 |
| 50-45-5 | 1.49 × 10⁴ | 44 | 0.51 | 26 | 144 | 54 |
| 40-60-0 | 2.66 × 10⁴ | 82 | 0.42 | 31 | | 67 |
| 40-55-5 | 1.76 × 10⁴ | 56 | 0.40 | 25 | | 60 |
| DOE | | 59 | | 41 | 40.5 | |
| Target | | | | | | |

Expanded Graphite vs. Natural Graphite

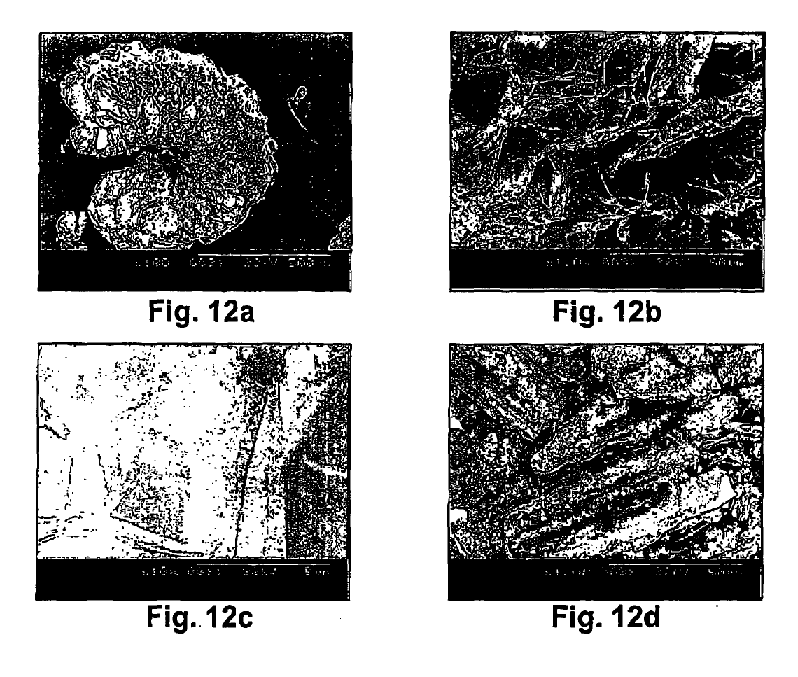

Expanded graphite (EG) is selected over natural or synthetic graphite due to separation of layered graphene structure, macro- and micro-pores, and graphite layer networks in the former. As detailed in FIGS. 12 (a), (b) and (c), this gives a very high surface area in the case of expanded graphite. Consequently, epoxy resins can go easily into the pores and interlayers of expanded graphite thereby intercalating the graphite. The layered structure and networks of graphite are maintained in the composites even after mixing and processing. On the other hand, natural or synthetic graphite particles do not have layered structures or pores (as shown in FIG. 12 (d)) and the surface area is much smaller than expanded graphite. Consequently, epoxy resin cannot penetrate into the graphite layers and instead surrounds the filler, thus forming an insulating inter-aggregate layer around the filler particles.

### Diffusion of Oxygen Through Composite

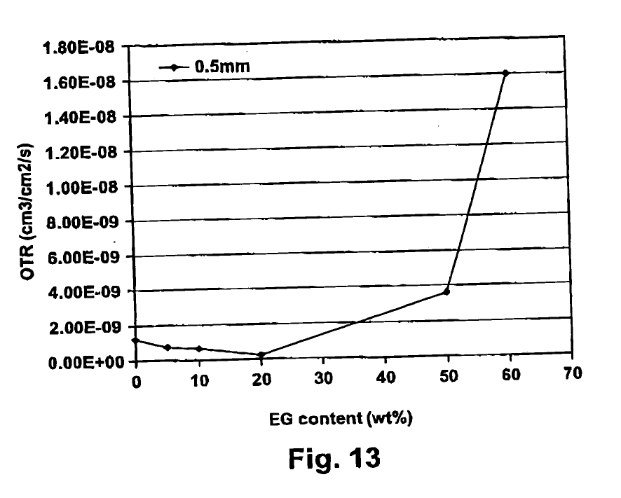

The diffusion of gaseous oxygen and hydrogen through these composite bipolar plates should be minimized in order to prevent admixture of these two gases at either electrodes. Note that admixture of gaseous oxygen and hydrogen may lead to spontaneous exothermic oxidation reaction and is a safety hazard in the operation of fuel cells. FIG. 13 presents oxygen transmission rate (OTR) at room temperature in cm³/s per 1 cm² area of the 0.5 mm thick composite. The platy nature of graphite particles prevents diffusion of oxygen through the composite as is evident from continuous reduction of OTR up to 20 wt % graphite content. However, at this loading, the composite does not give required electrical conductivity. The composite shows desired electrical conductivity at higher graphite loadings, but the composite also develops small voids with increased graphite loading. As a consequence, the OTR increases. As seen in FIG. 13, a composite with 60 wt % graphite allows very high OTR, indicating that this composite becomes unsuitable for fabrication of bipolar plates. As such, the data indicates that in one embodiment, a composite of 50 wt % graphite is desirable as it provides high values of electrical conductivity at moderate OTR.

Although the invention has been described in detail with particular reference to certain embodiments detailed herein, other embodiments can achieve the same results. Variations and modifications of the present invention will be obvious to those skilled in the art, and the present invention is intended to cover in the appended claims all such modifications and equivalents.

What is claimed is:

1. A method of manufacturing a polymer composite bipolar plate for use in a proton exchange membrane fuel cell comprising:
providing at least one epoxy, at least one curing agent, at least one graphite and at least one carbon black to a mixture; and
compression molding the mixture to initiate the curing reaction between the epoxy and curing agent.

2. The method of claim 1 wherein the plate is able to withstand continuous operating temperatures from about 30° C. to about 200° C. without deterioration.

3. The method of claim 1 wherein the at least one graphite is combined in a synergistic manner with the at least one carbon black, the at least one carbon black being particulate conductive carbon black and the combination producing a plate electrically conductive in the in-plane and through-plane directions.

4. The method of claim 1 wherein the plate provides in-plane electrical conductivity in the range of about 200 to about 500 S/cm.

5. The method of claim 1 wherein the plate has a glass transition temperature from about 150° C. to about 200° C.

6. The method of claim 1 wherein the plate thermally degrades at a temperature from about 350° C. to about 400° C.

7. The method of claim 1 wherein the at least one epoxy comprises at least one aromatic epoxy and at least one aliphatic epoxy and is mixed in a proportion of aromatic epoxy to aliphatic epoxy from 100:0 to about 70:30 by weight.

8. The method of claim 7 wherein the epoxies are crosslinked using diaminodiphenylsulphone.

9. The method of claim 1 wherein the at least one epoxy comprises diglycidyl ether of bipshenol A and ispolypropyleneglycol glycidyl ether.

10. The method of claim 9 wherein the diglycidyl ether of bipshenol A and the ispolypropyleneglycol glycidyl ether are crosslinked using diaminodiphenylsulphone.

11. The method of claim 1 wherein the method further includes the steps of adding acetone to the mixture to promote intercalation of the graphite and followed by evaporation of the acetone.

12. The method of claim 1 wherein the compression molding occurs at a temperature of about 180° C. and a pressure of about 4000 psi.

13. The method of claim 1 wherein the resultant composite varies from 40 weight percent to about 70 weight percent filler.

14. The method of claim 1 wherein the at least one carbon black is present at less than 5 weight percent filler.

15. The method of claim 1 wherein
the at least one epoxy is present from about 40 weight percent to about 60 weight percent,
the at least one graphite is present from about 35 weight percent to about 60 weight percent, and
the at least one carbon black is present at less than about 5 weight percent.

16. The method of claim 1 wherein the at least one graphite is expanded graphite.

17. A polymer composite for use as a bipolar plate in a proton exchange membrane fuel cell comprising:
at least one epoxy present from about 40 to about 60 weight percent;
at least one curing agent;
at least one graphite present from about 35 to about 60 weight percent; and
at least one carbon black present at less than about 5 weight percent.

18. The polymer composite of claim 17 wherein the bipolar plate withstands continuous operating temperatures from about 30° C. to about 200° C. without deterioration.

19. The polymer composite of claim 17 wherein the at least one graphite is combined in a synergistic manner with the at least one carbon black, the at least one carbon black being particulate conductive carbon black and the combination producing a plate electrically conductive in the in-plane and through-plane directions.

20. The polymer composite of claim 17 having an electrical conductivity from about 200 S/cm to about 500 S/cm.

21. The polymer composite of claim 17 having a composite glass transition temperature from about 150° C. to about 200° C.

22. The polymer composite of claim 17 wherein the one or more plates thermally degrade at a temperature from about 350° C. to about 400° C.

23. The polymer composite of claim 17 wherein the at least one epoxy contains at least one aromatic epoxy and at least one aliphatic epoxy and are mixed in proportions of aromatic epoxy to aliphatic epoxy from 100:0 to about 70:30 by weight.

24. The polymer composite of claim 23 wherein the epoxies are crosslinked using diaminodiphenylsulphone.

25. The polymer composite of claim 17 wherein the at least one epoxy contains at least one aromatic epoxy and at least one aliphatic epoxy and the aromatic epoxy is diglycidyl ether of bipshenol A and the aliphatic epoxy ispolypropyleneglycol glycidyl ether.

26. The polymer composite of claim 25 wherein the epoxy molecules are crosslinked using diaminodiphenylsulphone.

27. The polymer composite of claim 17 wherein acetone is added to promote intercalation of the graphite.

28. The polymer composite of claim 17 wherein compression molding occurs at a temperature of about 180° C. and a pressure of about 4000 psi.

29. The polymer composite of claim 17 wherein the resultant composite varies from 40 weight percent to about 70 weight percent filler.

30. The polymer composite of claim 17 wherein the at least one graphite is expanded graphite.
